(19) United States
(12) Patent Application Publication
(10) Pub. No.: US 2020/0313335 A1
(43) Pub. Date: Oct. 1, 2020

(54) CONNECTOR

(71) Applicant: Sumitomo Wiring Systems, Ltd., Yokkaichi-shi (JP)

(72) Inventors: Yuki Kondo, Yokkaichi-shi (JP); Long Chen, Yokkaichi-shi (JP)

(21) Appl. No.: 16/832,040

(22) Filed: Mar. 27, 2020

(30) Foreign Application Priority Data
Mar. 28, 2019 (JP) 2019-063899

(51) Int. Cl. H01R 13/426; H01R 13/436

(52) U.S. Cl. CPC H01R 13/426; H01R 2107/00; H01R 13/4367

(57) ABSTRACT

A connector (10) is to be mounted on an end part of a wire, and includes a terminal (20) and a housing. The housing includes a terminal accommodating portion (38). The terminal accommodating portion (38) has two side walls and a front wall (36). The side walls are arranged along the terminal (20), and the front wall (36) is provided between front end parts of the side walls. The terminal accommodating portion (38) includes a terminal accommodation opening (40). The terminal (20) is insertable into the terminal accommodation opening (40) in an intersecting direction intersecting a draw-out direction of the wire. At least one of the side walls includes a terminal locking portion (42) that projects from the side wall. The side wall formed with the terminal locking portion (42) and the front wall (36) are divided.

### BACKGROUND

### Field of the Invention

This disclosure relates to a connector.

### Related Art

Japanese Unexamined Patent Publication No. 2017-228447 discloses a shield connector with an inner housing for accommodating inner terminals. The inner housing is formed with terminal accommodation chambers including upwardly open upper-stage terminal accommodation chambers. Each terminal accommodation chamber has a terminal holding portion for holding the inner terminal. Each terminal holding portion has a stepped wall that projects laterally from a lateral wall of each terminal accommodation chamber. Each stepped wall is connected to a front wall of the terminal accommodation chamber, and a concave curved recess is formed in a lower part of the stepped wall.

The inner terminal is inserted into the terminal accommodation chamber through the upper-stage terminal accommodation opening and is held in the curved recess by the stepped wall. More particularly, the inner terminal is pushed through the upper stage terminal accommodation opening of the terminal accommodation chamber and is accommodated into the curved recess of the terminal accommodation chamber while pushing the stepped wall outward.

The stepped wall cannot project significantly from the lateral wall if the lateral wall of the terminal accommodation chamber is hard to deflect. Then, a locking margin of the stepped wall with the inner terminal is reduced and the inner terminal easily comes out from the terminal accommodation chamber.

A projecting dimension of the stepped wall could be increased. However, the inner terminal then must be pushed forcibly through the upper-stage terminal accommodation opening and the inner terminal may be deformed if the lateral wall is hard to deflect.

This connector disclosed in this specification prevents breakage of a terminal and prevents the terminal from easily coming out.

### SUMMARY

This disclosure relates to a connector with a housing made of resin and at least one terminal connected to an end of a wire. The housing has at least one terminal accommodating portion for accommodating the terminal such that the wire is drawn out rearwardly from the terminal accommodating portion. The terminal accommodating portion includes two side walls arranged along the terminal in a draw-out direction of the wire, and a front wall is provided between front ends of the side walls. A terminal accommodation opening is open into the terminal accommodating portion and is surrounded by the side walls and the front wall. The terminal is insertable into the terminal accommodating portion through the terminal accommodation opening in an intersecting direction that intersects the draw-out direction of the wire. A terminal locking portion projects from at least one of the side walls and is configured to lock the terminal accommodated in the terminal accommodating portion in the intersecting direction. The front wall and the side wall that has the terminal locking portion are divided.

Thus, the side wall formed with the terminal locking portion is deflected more easily in a direction opposite to a projecting direction of the terminal locking portion as compared to a case where the side wall with the terminal locking portion and the front wall are not divided.

That is, the side wall is easily deflectable so that the terminal can be inserted easily into the terminal accommodating portion while increasing a locking margin of the terminal locking portion and the terminal. In this way, the terminal will not be damaged during the insertion and is retained securely in the terminal accommodating portion.

A slit may be formed in the front wall at a boundary to the side wall that has the terminal locking portion. Consideration had been given to forming a slit in the side wall that has the terminal locking portion so that the side wall will deflect more easily. However, a slit in the side wall would reduce the rigidity of the side wall and could cause the side wall to break when being deflected and deformed. On the other hand, a slit in the front wall, as described above, enables the side wall to deflect and deform easily without reducing the rigidity of the side wall.

The slit may be a mold removal hole formed in front of the terminal locking portion. The mold removal hole may be used to form the terminal locking portion as well as being used to form the slit that divides the front wall and the side wall. In this way, the front wall is not complicated, as compared to the case where the slit is formed in the front wall separately from the mold removal hole. Further, the rigidity of the front wall is not reduced, as compared to the case where both the slit and the mold removal hole are formed in the front wall.

Accordingly the connector disclosed herein prevents breakage of a terminal and prevents the terminal from easily coming out.

### BRIEF DESCRIPTION OF DRAWINGS

FIG. 1 is an exploded perspective view of a connector.

FIG. 2 is a perspective view showing a state before a housing body and an inner cover are assembled.

FIG. 3 is a front view of the housing body.

FIG. 4 is a section, equivalent to a cross-section along IV-IV of FIG. 3, showing a process of accommodating terminals into the housing body.

FIG. 5 is a plan view showing a state where the terminals are inserted in terminal accommodating portions.

FIG. 6 is a section along VI-VI of FIG. 5.

FIG. 7 is a front view of a conventional housing body.

FIG. 8 is a section, corresponding to a cross-section of FIG. 6, showing the conventional housing body.

### DETAILED DESCRIPTION

A specific example of the connector of the present disclosure is described below with reference to the drawings. Note that the present disclosure is not limited to these illustrations and is intended to be represented by claims and include all changes in the scope of claims and in the meaning and scope of equivalents.

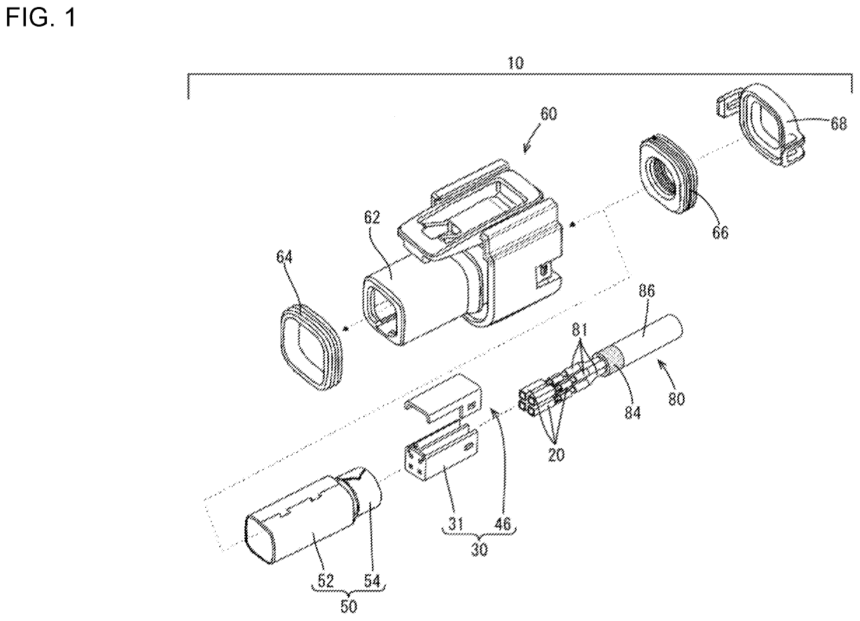

One embodiment in the present disclosure is described with reference to FIGS. 1 to 6. A connector 10 according to this embodiment is to be mounted on an end part of a shielded cable (an example of a “wire”) 80. As shown in FIG. 1, the connector 10 includes terminals 20 to be connected to an end of the shielded cable 80, an inner housing (an example of a “housing”) 30 for accommodating the terminals 20, an outer conductor 50 for covering the outer periphery of the inner housing 30 and an outer housing 60 for accommodating the outer conductor 50.

[Shielded Cable 80]

As shown in FIG. 1, the shielded cable 80 includes coated wires 81, a braided wire 84 for covering the outer periphery of the coated wires 81 and an outer coating 86 for covering the outer periphery of the braided wire 84. The shielded cable 80 of this embodiment includes four coated wires 81.

The braided wire 84 and the outer coating 86 are stripped at a front part of the shielded cable 80 to expose the coated wires 81. Only the outer coating 86 is stripped behind the exposed four coated wires 81 and the exposed braided wire 84 is folded back on the outer periphery of the outer coating 86.

[Terminals 20]

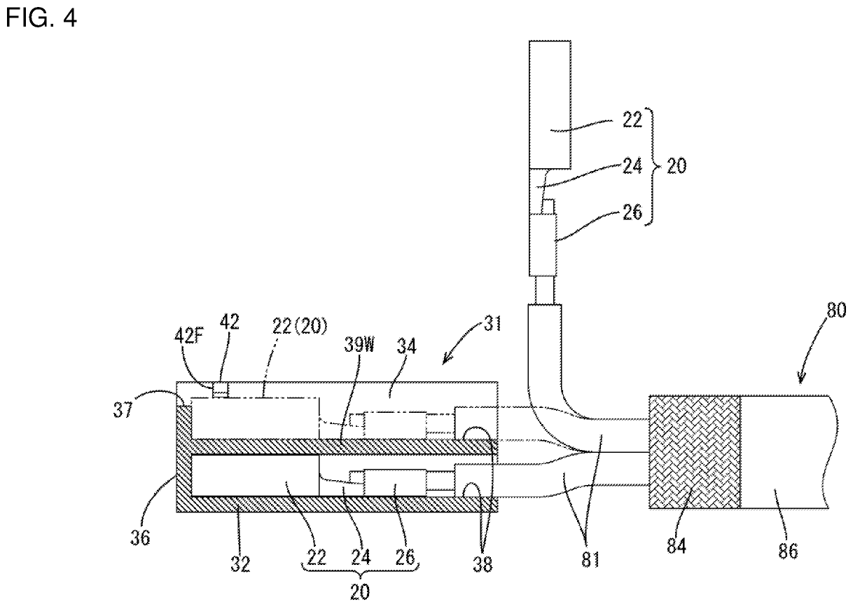

Each terminal 20 is formed by working a conductive metal plate material. Each terminal 20 is a female terminal and includes, as shown in FIG. 4, a terminal connecting portion 22 to be connected to an unillustrated mating terminal, a crimping portion 26 to be connected to the coated wire 81 of the shielded cable 80 and a linking portion 24 linking the terminal connecting portion 22 and the crimping portion 26. The terminal connecting portion 22 is a forwardly open rectangular tube. The crimping portion 26 is crimped and connected to a core exposed at an end of the coated wire 81.

[Inner Housing 30]

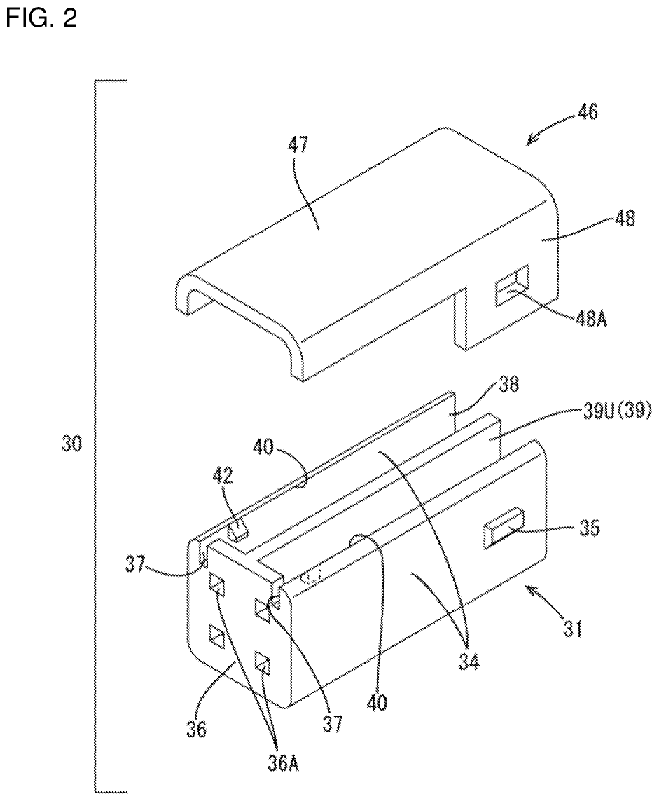

The inner housing 30 is made of insulating synthetic resin. As shown in. FIG. 2, the inner housing 30 includes a housing body (an example of the “housing”) 31 having a rectangular parallelepiped shape long in a front-rear direction, and an inner cover 46 to be assembled with the housing body 31 from above.

[Housing Body 31]

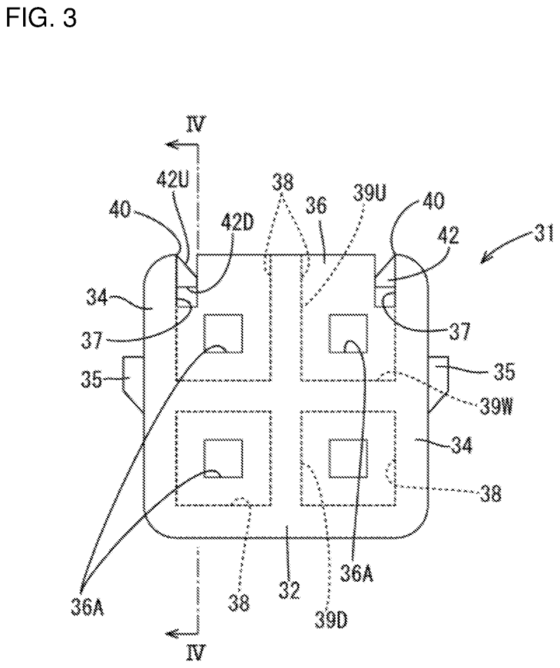

As shown in FIGS. 2 and 3, the housing body 31 includes a bottom wall 32, two outer side walls 34 extending up from both lateral sides of the bottom wall 32 and a front wall 36 provided between the outer side walls 34.

The bottom wall 32 is a flat rectangular flat plate long in the front-rear direction. The outer side walls 34 also are flat rectangular plates long in the front-rear direction and extending along the both lateral sides of the bottom wall 32. The front wall 36 is between front ends of the outer side walls 34 to link the pair of outer side walls 34. As shown in FIG. 3, rectangular terminal insertion holes 36A penetrate the front wall 36 in the front-rear direction at positions corresponding to the terminal accommodating portions 38 inside the housing body 31.

Slits 37 penetrate the front wall 36 in the front-rear direction in end parts of the front wall 36 on the sides of the outer side walls 34. Each slit 37 is rectangular and extends down from the upper end of the front wall 36 in a boundary part to the outer side wall 34. That is, the slit 37 divides upper end parts of the front wall 36 and the outer side wall 34.

[Terminal Accommodating Portions 38]

The terminal accommodating portions 38 are formed side by side in vertical and lateral directions inside the housing body 31. As shown in FIGS. 3 to 6, separation walls 39 are arranged in a cross-shape in an area surrounded by the bottom wall 32 and the outer side walls 34. The separation walls 39 extend in the front-rear direction over the entire length of the housing body 3 to divide the housing body 31 into four terminal accommodating portions 38.

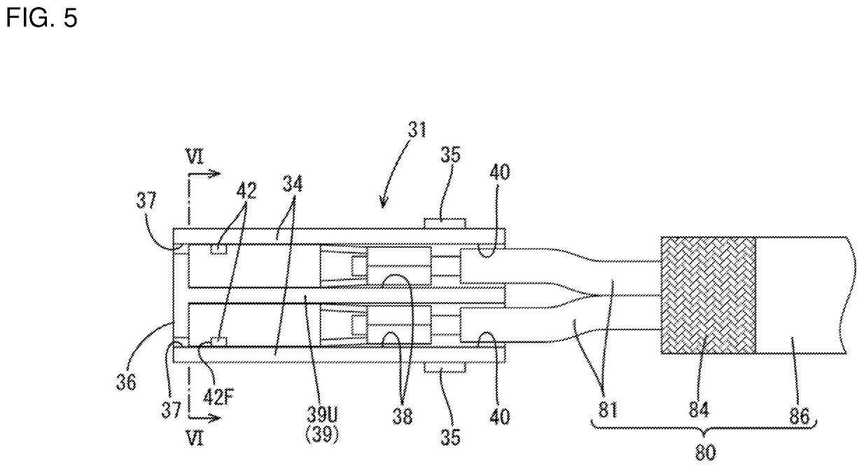

The terminals 20 can be accommodated respectively in the terminal accommodating portion 38 so that the four coated wires 81 are drawn out rearwardly from the housing body 31 as shown in FIGS. 4 and 5.

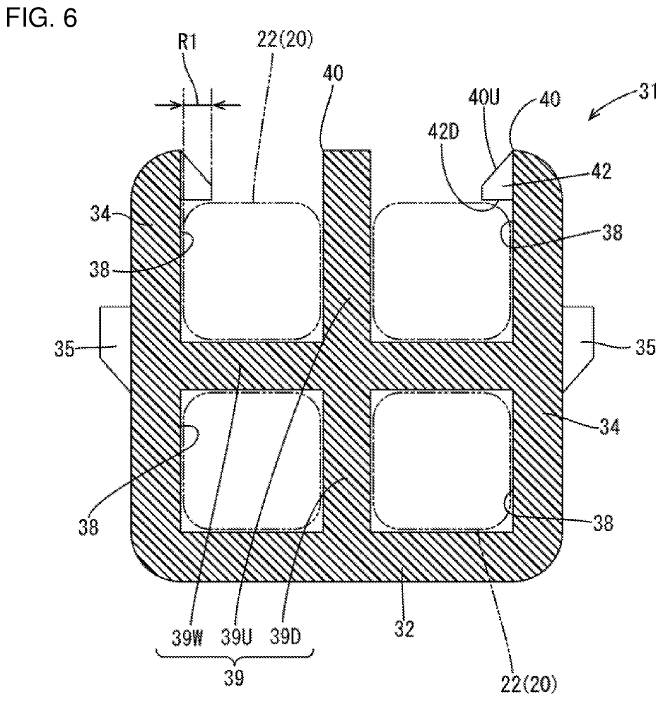

As shown in FIGS. 3 and 6, the separation walls 39 include a horizontal separation wall 39W in the form of a flat rectangular plate extending in the lateral direction between the outer side walls 34, an upper separation wall (an example of the “side wall”) 39U and a lower separation wall 39D in a laterally central part of the horizontal separation wall 39W. The horizontal separation wall 39W vertically faces the bottom wall 32, the lower separation wall 39D vertically links the horizontal separation wall 39W and the bottom wall 32, and the upper separation wall 39U extends up from the horizontal separation wall 39W.

A height of the upper separation wall 39U is substantially equal to lengths of the outer side walls 34 extending up from the position of the horizontal separation wall 39W, as shown in FIGS. 3 and 6. Substantially equal means a case where the height of the upper separation wall 39U is equal to the lengths of the pair of outer side walls 34 extending up from the horizontal separation wall 39W and a case where the height of the upper separation wall 39U and the lengths of the outer side walls 34 extending up from the horizontal separation wall 39W can be regarded as equal even if these dimensions are not equal.

Each of the terminal accommodating portions 38 in a lower stage is surrounded by the bottom wall 32, one of the outer side walls 34, the horizontal separation wall 39W and the lower separation wall 39D. That is, each terminal accommodating portion 38 in the lower stage has the outer side wall 34 and the lower separation wall 39D arranged along the terminal 20 in a draw-out direction of the coated wire 81, and the terminal 20 is inserted into this terminal accommodating portion 38 through a rectangular opening in the rear end of the housing body 31.

Each of the terminal accommodating portions 38 in an upper stage is surrounded by the horizontal separation wall 39W, one of the outer side walls 34 and the upper separation wall 39U. Each terminal accommodating portion 38 in the upper stage is formed with a terminal accommodation opening 40 through which the terminal 20 is inserted from above.

[Terminal Accommodation Openings 40]

As shown in FIG. 5, each terminal accommodation opening 40 is a rectangular opening that is open in an upward direction, which is a direction intersecting the draw-out direction of the coated wire 81. Each terminal accommodation opening 40 is surrounded by the outer side wall 34, the upper separation wall 39U and the front wall 36.

Accordingly, each terminal accommodating portion 38 in the upper stage has the outer side wall 34 and the upper separation wall 39U arranged along the terminal 20 in the draw-out direction of the coated wire 81, and the terminal 20 is inserted into this terminal accommodating portion 38 through the terminal accommodation opening 40.

As shown in FIGS. 2 to 6, a terminal locking portion 42 is formed on an opening edge part of the terminal accommodation opening 40 at a position to be above the terminal 20 accommodated in the terminal accommodating portion 38.

[Terminal Locking Portions 42]

Each terminal locking portion 42 projects into the terminal accommodating portion 38 from the upper end of the outer side wall 34. As shown in FIGS. 3 and 6, the upper surface of the terminal locking portion 42 is an inclined surface 42U inclined to approach the horizontal separation wall 39W toward the upper separation wall 39U, and the lower surface thereof defines a locking surface 42D vertically facing the horizontal separation wall 39W.

Accordingly, the terminal connecting portion 22 of the terminal 20 presses the inclined surface 42U of the terminal locking portion 42 in the process of inserting the terminal 20 through the terminal accommodation opening 40 and into the terminal accommodating portion 38 in the upper stage. Pressing forces exerted by the terminal connecting portion 22 on the inclined surface 42U of the terminal locking portion 42 resiliently displace the outer side wall 34 in a direction away from the upper separation wall 39U (lateral direction) with a lower end part of the slit 37 as a fulcrum. That is, the slit 37 divides the outer side wall 34 from the front wall 36 by the slit 37. As a result, the outer side wall 34 easily is displaced resiliently in the direction away from the upper separation wall 39U as compared to the case where an outer side wall and a front wall are connected over the entire height in the vertical direction.

The outer side wall 34 resiliently returns when the terminal connecting portion 22 rides over the terminal locking portion 42 and is accommodated into the terminal accommodating portion 38, as shown in FIG. 6. Thus, the locking surface 42D of the terminal locking portion 42 vertically faces the terminal connecting portion 22 with a large locking margin R1 to prevent the terminal 20 from coming out of the terminal accommodation opening 40.

A front surface 42F of the terminal locking portion 42 faces forward from the slit 37 of the front wall 36 in the housing body 31, as shown in FIGS. 4 and 5. That is, the slit 37 is a mold removal hole of a mold part for molding the front surface 42F of the terminal locking portion 42 when the housing body 31 is molded by a mold that opens in the front-rear direction.

[Inner Cover 46]

As shown in FIG. 2, the inner cover 46 includes a ceiling wall 47 dimensioned to collectively cover the two terminal accommodation openings 40 from above. Locking pieces 48 are provided respectively on lateral sides of the ceiling wall 47 and are resiliently displaceable in the lateral direction. Locking holes 48A penetrate through the locking pieces 48 in the lateral direction and receive locking projections 35 on the outer side walls 34.

When the inner cover 46 is assembled with the housing body 31, the ceiling wall 47 collectively covers the two terminal accommodation openings 40 from above and the locking projections 35 of the outer side walls 34 are fit into the locking holes 48A of the locking pieces 48 to fix the locking pieces 48 to the outer side walls 34.

[Outer Conductor 50]

The outer conductor 50 is formed by working a conductive metal plate material. As shown in FIG. 1, the outer conductor 50 includes an outer conductor body 52 in the form of a rectangular tube for covering the outer periphery of the inner housing 30 and a hollow cylindrical shield crimping portion 54 connected behind the outer conductor body 52. The outer conductor 50 is connected to the braided wire 84 by crimping the shield crimping portion 54 to the braided wire 84 folded back on the outer periphery of the outer coating 86.

[Outer Housing 60]

The outer housing 60 is made of insulating synthetic resin and is in the form of a rectangular tube, as shown in FIG. 1. The outer conductor 50 connected to the front part of the shielded cable 80 can be accommodated into the outer housing 60.

A front part of the outer housing 60 defines a fitting portion 62 to be fit to an unillustrated mating connector. A first sealing member 64 is mounted on the outer periphery of the fitting portion 62 for sealing between the fitting portion 62 and the mating connector. A second sealing member 66 for sealing between the shielded cable 80 and the outer housing 60 and a rear holder 68 for retaining the second sealing member 66 are mounted on a rear part of the outer housing 60.

This embodiment is configured as described above. Next, functions and effects of the connector 10 are described.

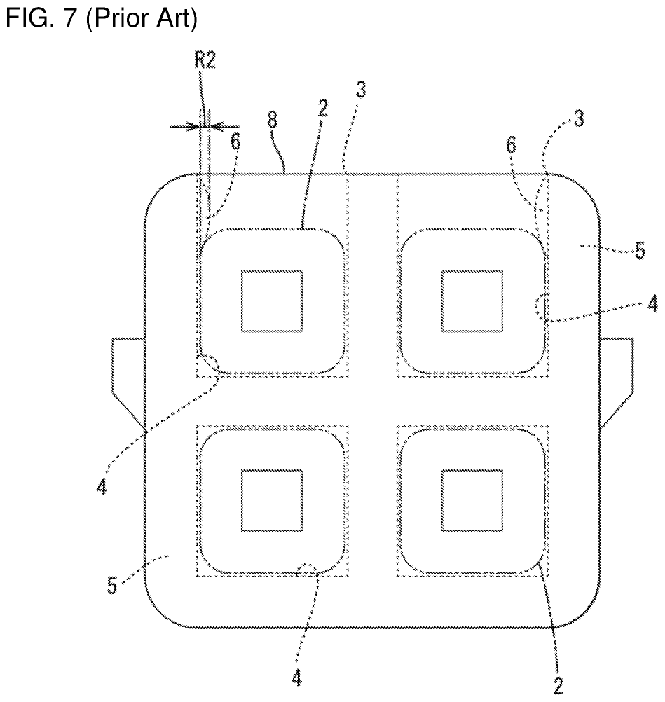

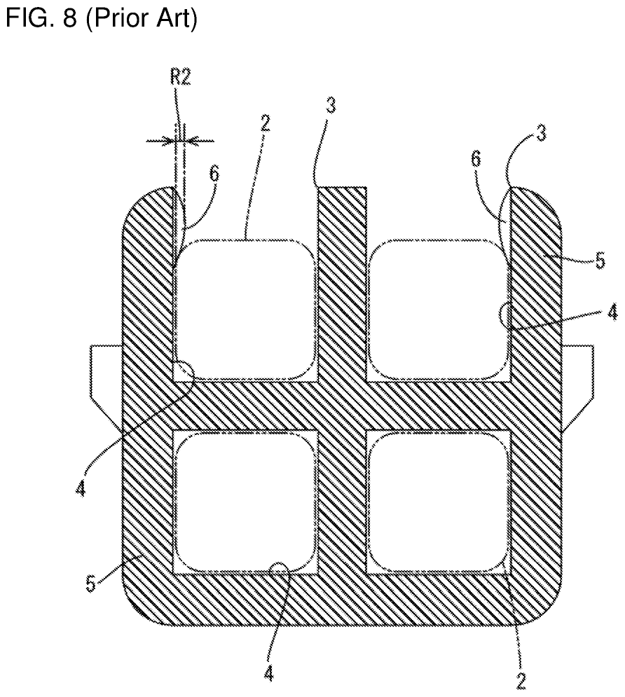

A conventional housing body 10 is shown in FIGS. 7 and 8 and has a terminal 2 pushed into a terminal accommodating portion 4 through a terminal accommodation opening 3. The terminal 2 is accommodated into the terminal accommodating portion 4 while pressing a terminal locking portion 6 formed on a side wall 5 to push the side wall 5 outwardly.

However, as shown in FIG. 7, the side wall 5 in the conventional housing body 1 is coupled to a front wall 8 over the entire height and is hard to deflect. Thus, a projecting dimension of the terminal locking portion 6 from the side wall 5 cannot be increased, as shown in FIGS. 7 and 8. Then, a locking margin R2 of the terminal locking portion 6 with the terminal 2 is small, and the terminal 2 easily comes out from the terminal accommodating portion 4.

The locking margin of the terminal locking portion with the terminal 2 can be increased, for example, by increasing a projecting amount of the terminal locking portion 6. However, if the locking margin of the terminal locking portion with the terminal 2 is large, the terminal 2 is pushed forcibly through the terminal accommodation opening 3 and may be deformed since the side wall 5 is hard to deflect.

Accordingly, the present inventors found out the configuration of this embodiment as a result of an earnest study to solve the above problem. Specifically, this embodiment relates to the connector 10 to be mounted on the end part of the shielded cable (wire) 80, and includes at least one terminal 20 and the inner housing (housing) 30 made of resin.

The terminal 20 is connected to the end of the coated wire 80 of the shielded cable 80, the inner housing 30 includes at least one terminal accommodating portion 38 to accommodate the terminal 20. The terminal accommodating portion 38 includes outer side walls 34 and the front wall 36, and the coated wire 81 is drawn out rearwardly from the terminal accommodating portion 38.

The two outer side walls 34 are arranged along the terminal 20 in the draw-out direction of the coated wire 81, and the front wall 36 is provided between the front parts of the outer side walls 34. The terminal accommodating portion 38 includes the terminal accommodation opening 40 that is surrounded by the outer side walls 34 and the front wall 36. The terminal 20 is insertable through the terminal accommodation opening 40 in an interesting direction intersecting the draw-out direction of the coated wire 81.

The terminal locking portion 42 projects from at least one of the outer side walls 34 to lock the terminal 20 accommodated in the terminal accommodating portion 38 in the intersecting direction. As shown in FIGS. 2, 3, 5 and 6, the outer side wall 34 formed with the terminal locking portion 42 and the front wall 36 are divided. Thus, the outer side wall 34 formed with the terminal locking portion 42 is deflected more easily in a direction opposite to a projecting direction of the terminal locking portion 42, for example, as compared to the case where the side wall 5 formed with the terminal locking portion 6 and the front wall 8 are coupled over the entire height as shown in FIG. 7.

The easily deflectable outer side wall 34 facilitates insertion of the terminal 20 into the terminal accommodating portion 38 through the terminal accommodation opening 40, while the locking margin R1 of the terminal locking portion 42 and the terminal 20 is increased. In this way, the terminal 20 is unlikely to be damaged during the insertion and is retained securely in the terminal accommodating portion 38.

A slit could be formed in the side wall that has the terminal locking portion so that the side wall could deflect more easily. However, such a slit would reduce the rigidity of slit the side wall, and the less rigid side wall may break when being deflected and deformed. Accordingly, the slits 37 are formed in the front wall 36 in this embodiment. Thus, the outer side walls 34 can be made easily deflectable without reducing the rigidity of the outer side walls 34.

The slits 37 are forward of the terminal locking portions 42 and may be mold removal holes formed when molding the terminal locking portions 42. Thus, the mold removal holes divide the front wall 36 from the outer side walls 34 that have the terminal locking portions 42. Accordingly, the mold removal holes can double as the slits for dividing the front wall 36 and the outer side walls 34. Therefore, the front wall 36 is less complicated than the case where slits are formed in a front wall separately from mold removal holes. Further, a reduction in the rigidity of the front wall 36 can be prevented, for example, as compared to the case where both slits and mold removal holes are formed in a front wall.

### Other Embodiments

In the above embodiment, the inner housing 30 includes the housing body 31 and the inner cover 46 to be assembled with the housing body 31. However, there is no limitation to this and an inner housing may include no inner cover.

In the above embodiment, the mold removal holes formed when forming the terminal locking portions 42 double as the slits 37 for dividing the front wall 36 and the outer side walls 34. However, there is no limitation to this and slits different from mold removal holes may be provided individually in a front wall without providing any mold removal hole in the front wall, such as by forming terminal locking portions by a slide mold.

In the above embodiment, the inner housing 30 includes four terminal accommodating portions 38. However, there is no limitation to this and one, two, three, five or more terminal accommodating portions may be provided.

In the above embodiment, the terminal locking portions 42 are provided only on the outer side walls 34. However, there is no limitation to this and terminal locking portions may be formed on both outer side walls and an upper separation wall.

In the above embodiment, the connector 10 includes the outer conductor 50 and the outer housing 60 to be mounted on the shielded cable 80. However, there is no limitation to this and the technique disclosed in this specification may be applied to a connector including neither an outer conductor nor an outer housing and to be mounted on a coated wire.

### LIST OF REFERENCE SIGNS

1: inner housing
2: terminal
3: terminal accommodation opening
4: terminal accommodating portion
5: side wall
6: terminal locking portion
10: connector
20: terminal
22: terminal connecting portion
24: linking portion
26: crimping portion
30: inner housing (example of “housing”)
31: housing body (example of “housing”)
32: bottom wall
34: outer side wall (an example of “side wall”)
35: locking projection
36: front wall
36A: terminal insertion hole
37: slit
38: terminal accommodating portion
39: separation wall
39D: lower separation wall
39U: upper separation wall
39W: horizontal separation wall
40: terminal accommodation opening
42: terminal locking portion
42D: locking surface
42F: front surface
42U: inclined surface
46: inner cover
47: ceiling wall
48: locking piece
48A: locking hole
50: outer conductor
52: outer conductor body
54: shield crimping portion
60: outer housing
62: fitting portion
64: first sealing member
66: second sealing member
68: rear holder
80: shielded cable (example of “wire”)
82: coated wire
84: braided wire
86: outer coating
R1: locking margin

R2: locking margin

What is claimed is:

1. A connector (10) to be mounted on an end part of a wire (80), comprising:
at least one terminal (20); and
a housing (30) made of resin,
wherein:
the terminal (10) is connected to an end of the wire (80),
the housing (30) includes at least one terminal accommodating portion (38),
the terminal accommodating portion (38) is formed to include two side walls (34) and a front wall (36) and accommodates the terminal (20), and the wire (80) is drawn out rearwardly from the terminal accommodating portion (38),
the side walls (34) are arranged along the terminal (20) in a draw-out direction of the wire (80),
the front wall (36) is provided between front end parts of the side walls (34),
the terminal accommodating portion (38) includes a terminal accommodation opening (40),
the terminal accommodation opening (40) is formed by being surrounded by the side walls (34) and the front wall (34) and the terminal (20) is insertable through the terminal accommodation opening (40) in an intersecting direction intersecting the draw-out direction of the wire (80),
at least one of the side walls (34) includes a terminal locking portion (42),
the terminal locking portion (42) projects from the side wall (34) so as to be capable of locking the terminal (20) accommodated in the terminal accommodating portion (20) in the intersecting direction, and
the side wall (34) formed with the terminal locking portion (42) and the front wall (36) are divided.

2. The connector (10) of claim 1, wherein the front wall (36) is formed with a slit (37) in a boundary part to the side wall (34) that has the terminal locking portion (42).

3. The connector (10) of claim 2, wherein the slit (37) is a mold removal hole formed in front of the terminal locking portion (42).
